(19) United States
(12) Patent Application Publication
(10) Pub. No.: US 2006/0004714 A1
(43) Pub. Date: Jan. 5, 2006

(54) Transposition search method for optimal topology construction

(75) Inventor: George V. Popescu, Stamford, CT (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 10/880,914

(22) Filed: Jun. 30, 2004

(51) Int. Cl. G06F 17/30

(52) U.S. Cl. 707/3

(57) ABSTRACT

A new search algorithm for optimal topology construction which utilizes a sequence of transpositions of the topology adjacency matrix index. Preferably, the search involves: evaluating an objective function for each transposition of the current index permutation state; selecting the transposition corresponding to the gradient of the objective function at convex regions of the permutation space; and allowing the transposition search to follow a positive gradient within an window length equal to the maximum distances between local edge objective minima.

### FIELD OF THE INVENTION

The present invention relates generally to search methods for optimal topology construction.

### BACKGROUND OF THE INVENTION

A recent graph optimization problem generated in connection with topology construction for distributed indexing applications is the optimal embedding of an interconnection network of n nodes to a network overlay of n nodes. More generally, the problem is formulated as follows: given a graph G(V,E) with node indexing I1(V) and a topology metric matrix A with an indexing I2, find the embedding of I1 on I2 such that a objective function O(G, A) is minimized. The problem has non-polynomial computation complexity and therefore requires efficient approximation algorithms.

An example of topology construction problem is the optimal embedding of an interconnection topology to a network overlay. The interconnection network has a regular structure: edges between topology nodes are selected according to interconnection network topology construction rules. For example in a binary deBruijn network, each node is connected to nodes with indices obtained by applying left/right shift and complement operators to the current node binary code. Given an indexing of interconnection network nodes, the adjacency matrix is determined by specific rules for topology construction.

The topology construction objective is a functional evaluation of the selected topology metric values given an instance of the topology. An example of objective function is the average network distance between topology nodes, or equivalently the sum of all edge delays in the interconnection topology. For a given indexing of the network overlay nodes, the value of objective function is obtained as the average of delay values of all edges in the topology generated by the current indexing.

In view of the shortcoming and disadvantages presented by previous efforts, a need has been recognized in connection with providing a much more efficient algorithm for optimal topology construction.

### SUMMARY OF THE INVENTION

There is broadly contemplated herein, in accordance with at least one presently preferred embodiment of the present invention, a new search algorithm for optimal topology construction which utilizes a sequence of transpositions of the topology adjacency matrix index. Preferably, the search involves: evaluating an objective function for each transposition of the current index permutation state; selecting the transposition corresponding to the gradient of the objective function at convex regions of the index permutation space; and allowing the transposition search to follow a positive gradient within an window length equal to the maximum distances between local objective minima.

Preferably utilized in that connection is an iterative search method which performs a sequence of graph vertex index transpositions. The generic optimal topology construction problem is thus preferably modeled as follows: given a topology metric matrix, a topology adjacency matrix, and a objective function that depends on the value of topology metric matrix elements selected by an instantiation of the topology, find the instantiation of the topology that minimizes the objective.

The topology construction methods broadly contemplated herein preferably utilize two sets of indices: the topology indices and the topology metric indices. The search for the optimal topology is essentially equivalent to the search for the permutation of the topology matrix indices that correspond to the minimum objective. The search methods broadly contemplated herein perform a sequence of transpositions of topology metric indices until a minimum of the objective function is found. A primary associated advantage is the exceptional efficiency of the search.

In summary, one aspect of the invention provides a method of providing a transposition search for optimal topology construction, the method comprising the steps of: evaluating an objective function for each transposition of a current index permutation state; selecting a transposition corresponding to a gradient of an objective function; and continuing the transposition search via following a gradient within a search window.

Another aspect of the invention provides an apparatus for providing a transposition search for optimal topology construction, the apparatus comprising: an arrangement for evaluating an objective function for each transposition of a current index permutation state; an arrangement for selecting a transposition corresponding to a gradient of an objective function; and an arrangement for continuing the transposition search via following a gradient.

Furthermore, an additional aspect of the invention provides a program storage device readable by machine, tangibly embodying a program of instructions executable by the machine to perform method steps for providing a transposition search for optimal topology construction, the method comprising the steps of: evaluating an objective function for each transposition of a current index permutation state; selecting a transposition corresponding to a gradient of an objective function; and continuing the transposition search via following a gradient.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 provides a deBruijn adjacency matrix prior to index transposition.

FIG. 2 graphically depicts the transposition of a deBruijn graph.

FIG. 3 provides a deBruijn adjacency matrix after index transposition FIG. 4 provides a transposition search algorithm.

### DESCRIPTION OF THE PREFERRED EMBODIMENTS

Consider an indexing of the topology metric I2=1 . . . N, and an indexing of the topology I1=1 . . . N. The topology metric matrix A, a(ij), i,j=1 . . . N, contains the values of a topology metric function evaluated between all pairs of indices.

An example of a topology metric function is the network delay between any two nodes of a network topology. The topology matrix C, c(ij), i,j=1 . . . N, contains the values of a function of topology evaluated between any pair of nodes. An example of a topology function is a binary function indicating the presence of a link between a pair of topology nodes. In this case, C is the adjacency matrix of the topology.

Consider a permutation P of topology metric indices: P(I2)=I1, I2=1 . . . N, I1=1 . . . N. The objective is a function of the topology metric matrix and of the instance of the topology obtained by applying the permutation P. An example of objective function is the average topology metric value for an instance of a topology.

Without losing generality, consider that the indexing of the topology metric matrix is the identical permutation of [1 . . . N]. An instance of the topology is uniquely determined by the non-null entries of the permuted topology adjacency matrix. Proposed herebelow in accordance with at least one presently preferred embodiment of the present invention are algorithms for searching the permutation of the adjacency matrix indices corresponding to the minimum of the objective function.

Accordingly, the exhaustive search for the optimal permutation is a search over the N! distinct permutations of the topology indices. Let π:[1 . . . N]->[1 . . . N] be a permutation over topology metric matrix indices with values on the topology indices, I1=I1(j), j=1 . . . N. Given the two matrices A and C, the objective function can be written as:

$$O ( P ) = {\sum }_{i = 1}^{N} {\sum }_{j = 1}^{N} {a}_{ij} {c}_{π ( i ) π ( j )}$$

In matrix notation the objective function for a permutation of indices is:
O(P)=Trace (AP^{T}C^{T}P)

The permutation matrix P is obtained by arranging the columns of the identity matrix in the order given by the current index permutation P. By multiplying to the left and right of the transposed adjacency matrix, its rows and columns indices are permuted in the order of permutation π.

Accordingly, it is proposed in accordance with at least one preferred embodiment of the present invention that the optimal permutation (corresponding to the minimum value of the objective function O(Popt)) be searched for using a sequence of transpositions of topology node indices. Starting from the current permutation, there are N(N-1)/2-1 pairs of indices to be evaluated; after evaluation of the changes of the objective function for the entire set (or a subset) of transpositions, the next permutation state is selected.

In the matrix formulation, the transposition of pairs of node indices corresponds to exchanging two rows and two columns of the network adjacency matrix. Evaluating only the changes of objective function reduces the computation complexity of each step of the search iteration to a constant factor of the maximum per node connectivity of the topology.

As an example, consider the adjacency matrix for the binary deBruijn network with N=8 nodes, UB(2,3).

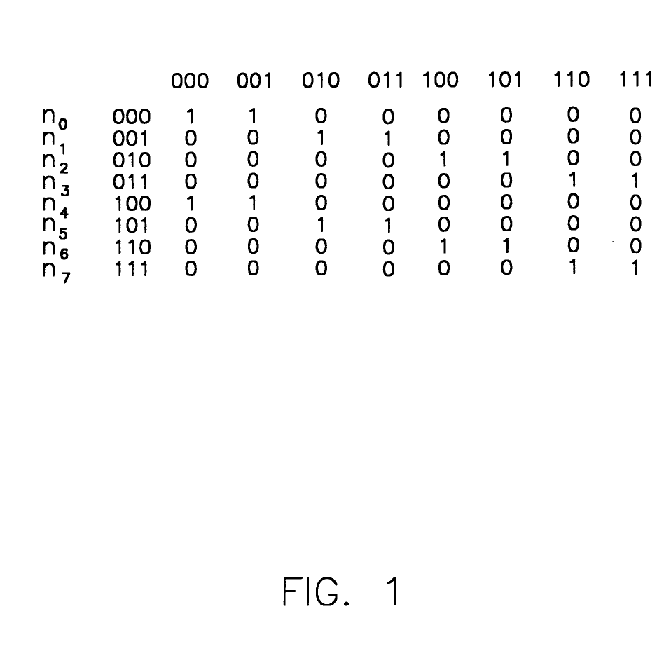

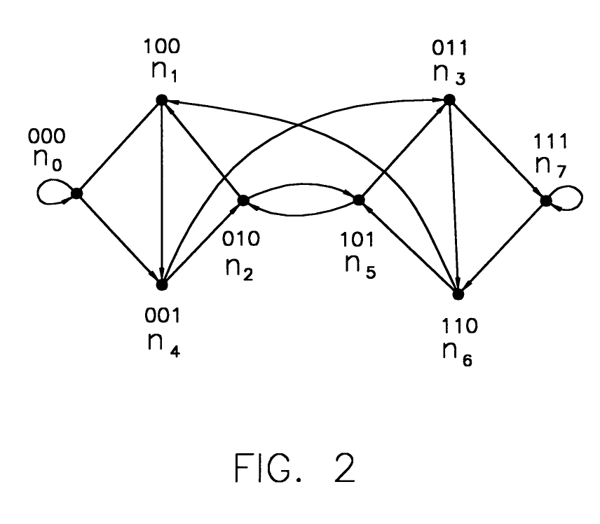

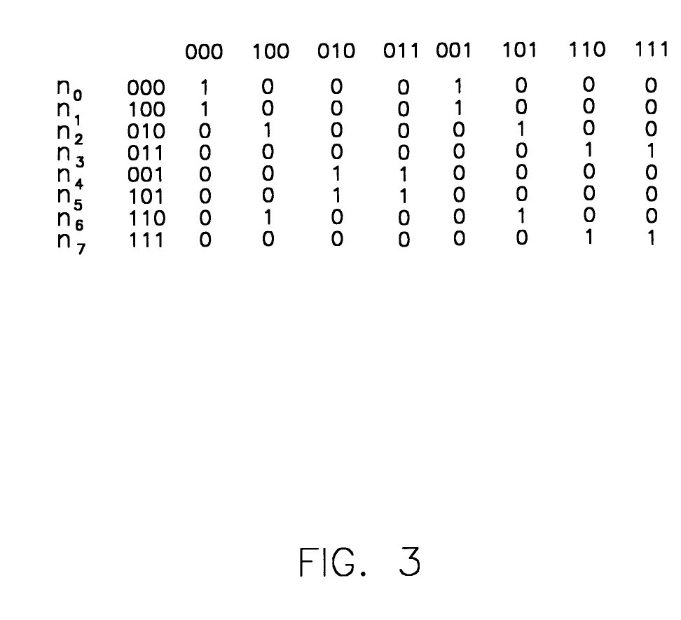

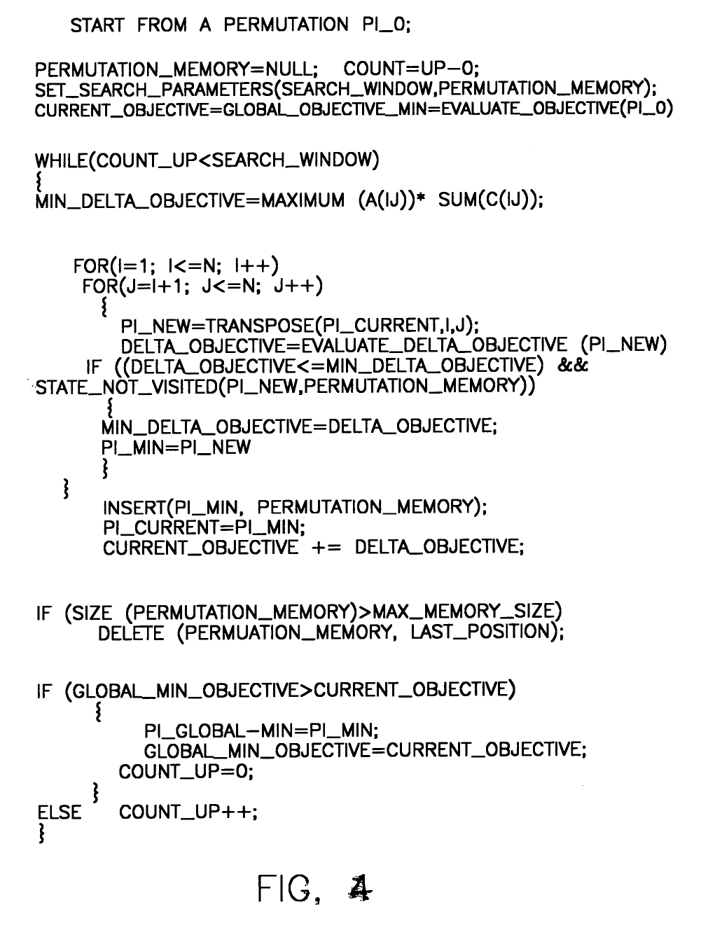

In the UB(2,3) the maximum node connectivity is 4; the maximum number of changes in the set of selected edges is eight (8 edges leave while 8 enter); in the set of edges when switching the indices of nodes which are not adjacent in the deBruijn graph; the number of edge changes is reduced by the number of connection between the nodes in the deBruijn graph. The adjacency matrix before and after the transposition of indices corresponding to nodes n1 and n4 is depicted in FIGS. 1 and 3, respectively. The deBruijn graph after the transposition of indices is shown in FIG. 2.

The transposition search selects the direction of search by computing the change in the objective function for all permutation of indices accessible from the current index permutation through a transposition. The index permutation at step k+1 is obtained by transposing the indices p* and q*, p*,q*ε {1 . . . N} of the step k πₖ₊₁=πₖ*t(p*,q*).

The change in objective function when transposing indices p* and q* of the index permutation πₖ is:

$$\begin{matrix}D ( O ) = [ \begin{matrix}{\sum }_{{i = 1}_{i \neq {p}^{*} , i \neq {q}^{*}}}^{N} {a}_{{ip}^{*}} {c}_{{π}_{k} ( i ) {π}_{k} ( {q}^{*} )} + {\sum }_{{i = 1}_{i \neq {p}^{*} , i \neq {q}^{*}}}^{N} {a}_{{iq}^{*}} {c}_{{π}_{k} ( i ) {π}_{k} ( {p}^{*} )} + \\ {\sum }_{{i = 1}_{i \neq {p}^{*} , i \neq {q}^{*}}}^{N} {a}_{{p}^{*} i} {c}_{{π}_{k} ( {q}^{*} ) {π}_{k} ( i )} + {\sum }_{{i = 1}_{i \neq {p}^{*} , i \neq {q}^{*}}}^{N} {a}_{{q}^{*} i} {c}_{{π}_{k} ( {p}^{*} ) {π}_{k} ( i )}\end{matrix} ] - \\ [ \begin{matrix}{\sum }_{{i = 1}_{i \neq {p}^{*} , i \neq {q}^{*}}}^{N} {a}_{{ip}^{*}} {c}_{{π}_{k} ( i ) {π}_{k} ( {p}^{*} )} + {\sum }_{{i = 1}_{i \neq {p}^{*} , i \neq {q}^{*}}}^{N} {a}_{{iq}^{*}} {c}_{{π}_{k} ( i ) {π}_{k} ( {q}^{*} )} + \\ {\sum }_{{i = 1}_{i \neq {p}^{*} , i \neq {q}^{*}}}^{N} {a}_{{p}^{*} i} {c}_{{π}_{k} ( {p}^{*} ) {π}_{k} ( i )} + {\sum }_{{i = 1}_{i \neq {p}^{*} , i \neq {q}^{*}}}^{N} {a}_{{q}^{*} i} {c}_{{π}_{k} ( {q}^{*} ) {π}_{k} ( i )}\end{matrix} ] \\ [ \begin{matrix}{a}_{{p}^{*} {p}^{*}} {c}_{{π}_{k} ( {q}^{*} ) {π}_{k} ( {q}^{*} )} + {a}_{{q}^{*} {q}^{*}} {c}_{{π}_{k} ( {p}^{*} ) {π}_{k} ( {p}^{*} )} + \\ {a}_{{p}^{*} {q}^{*}} {c}_{{π}_{k} ( {q}^{*} ) {π}_{k} ( {p}^{*} )} + {a}_{{q}^{*} {p}^{*}} {c}_{{π}_{k} ( {p}^{*} ) {π}_{k} ( {q}^{*} )}\end{matrix} ] - \\ [ \begin{matrix}{a}_{{p}^{*} {p}^{*}} {c}_{{π}_{k} ( {p}^{*} ) {π}_{k} ( {p}^{*} )} + {a}_{{q}^{*} {q}^{*}} {c}_{{π}_{k} ( {q}^{*} ) {π}_{k} ( {q}^{*} )} + \\ {a}_{{p}^{*} {q}^{*}} {c}_{{π}_{k} ( {p}^{*} ) {π}_{k} ( {q}^{*} )} + {a}_{{q}^{*} {p}^{*}} {c}_{{π}_{k} ( {q}^{*} ) {π}_{k} ( {p}^{*} )}\end{matrix} ]\end{matrix} \qquad ( 1 )$$

The objective function difference can be evaluated using only half of the summation terms for an undirected graph topology (e.g. use only the summation over the row indices).

The transposition search selects the direction of search by computing first the difference of objective function D(O) for all index permutations in the local neighborhood of the current permutation. The local neighborhood of a permutation is the set of all permutations accessible through transpositions of node indices.

The transposition search algorithm selects the index transposition that corresponds to the maximum decrease of edge cost on the convex regions of the index permutation space. Each step of the transposition search evaluates D(O) for all transpositions of current indices, and exchanges the indices corresponding to the maximum objective function decrease. The computation of local gradient is efficient: only N(N−1)/2−1 permutation states are accessible from the any permutation state through transpositions.

Consider one step of the transposition search that consists of exchanging indices p* and q*. The transposition of indices p* and q* of the current permutation of topology metric indices involves only the edges: n(p*)->n(j), n(j)->n(p*), n(i)->n(q*), n(q*)->n(i) (removed), n(q*)->n(j), n(j)->n(q*), n(i)->n(p*), n(p*)->n(i) (added), i,j=1 . . . N ; the edges selected by the matrix c(πₖ (p*), πₖ (q*)) are removed, while those selected by c(πₖ₊₁ (p*), πₖ₊₁ (q*))—corresponding to the current permutation πₖ of adjacency matrix indices—are added.

For an undirected topology graph the number of edges modified at each step is twice the sum of in degree and out degree of nodes n(p*) and n(q*) minus the number of common edges between n(p*) and n(q*). The objective function change (1) is computed by adding the topology metric values corresponding to the added edges and subtracting the values corresponding to the topology edges removed.

The computational complexity of one transposition step is linear with respect to the dimension of the adjacency matrix; at most O(N) operations are involved when exchanging the indices of nodes with (maximum) degree N−1 for an undirected topology graph. For the UB(2,log(N)) deBruijn topology the maximum number of computations when exchanging the indices of nodes which are not connected is 4N.

A transposition search algorithm for the permutation corresponding to the minimum objective allows the selection of permutation states with higher objective. The number of search steps with an objective higher than a local search minimum is restricted to a search window of length equal to the maximum length objective decreasing transposition sequence. The selection of already visited permutation states is prevented by using a memory of permutation states of length equal to the maximum number of states accessible from a permutation state. A transposition search algorithm which may be realized in accordance with a preferred embodiment of the present invention is presented in FIG. 4.

The search_window is preferably set such that its value is proportional to the maximum number of topology edges: for the deBruijn graph this is ct1*N*log(N)/2.

The value of mem_wnd is set proportional to the number of states accessible through a transposition search: ct2*N(N−1)/2. The transposition search keeps a number max_memory_size most recent permutation states visited; the loops in the permutation state shorter than ct2*N(N−1)/2 are avoided.

By way of possible applications of a transposition search algorithm, one may consider construction overlay topologies for distributed indexing applications: Distributed indexing applications are supported by overlay topologies with constraints on average message routing overhead. The overlay topologies for distributed indexing applications have logarithmic (with the number of overlay nodes) diameter, logarithmic degree of resilience (number of independent paths between two nodes), and have logarithmic topology extension/attrition overhead. In addition overlay topologies can be optimized for minimizing average routing delay. The transposition search algorithm can be used for construction of such overlay topology by embedding—with minimum average edge delay—an interconnection network (e.g. deBruijn) in a network graph.

Another possible application of a transposition search algorithm is the efficient mapping of application partitions to distributed server nodes. In this vein, consider that a set of applications topics are partitioned into N sub-sets P(i) of different cardinality, each mapped to one of the M server nodes S(j). An overhead function—F_overhead (P(i),S(j)) i=1 . . . N, j=1 . . . M—which depends on the mapping between application partitions and server nodes is pre-computed (in a table look-up) or can be functionally evaluated. The objective of the mapping is the minimization of the total partition mapping overhead. The transposition search algorithm presented herein can be used to search for the mapping with the minimum average overhead: starting from an arbitrary mapping of partitions to applications; the search changes the indices of pairs of partitions at each step and select the configuration that corresponds to the minimum overhead. By iterating the partition index transposition, the overhead corresponding to an instance of mapping of partitions to servers is minimized.

It is to be understood that the present invention, in accordance with at least one presently preferred embodiment, includes an arrangement for evaluating an objective function for each transposition of a current index permutation state, an arrangement for selecting a transposition corresponding to a gradient of an objective function, and an arrangement for continuing the transposition search via following a gradient. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method of providing a transposition search for optimal topology construction, said method comprising the steps of:
evaluating an objective function for each transposition of a current index permutation state;
selecting a transposition corresponding to a gradient of an objective function; and
continuing the transposition search via following a gradient within a search window.

2. The method according to claim 1, wherein said selecting step comprises selecting a transposition corresponding to a gradient of an objective function at convex regions of an index permutation space.

3. The method according to claim 1, wherein said step of continuing the transposition search comprises continuing the transposition search via following a gradient within a window length equal to the maximum distances between local objective minima.

4. The method according to claim 1, wherein said step of continuing the transposition search comprises performing an iterative search which performs a sequence of graph vertex index transpositions.

5. The method according to claim 1, wherein said step of continuing the transposition search comprising selecting a direction of search via computing the difference of an objective function for all index permutations in a local neighborhood of a current permutation.

6. The method according to claim 4, wherein the local neighborhood of the current permutation comprises a set of all permutations accessible through transpositions of node indices.

7. The method according to claim 1, further comprising the step of modeling an overlay topology construction as an embedding of an interconnection graph in a complete network overlay graph.

8. The method according to claim 1, wherein said providing of a transposition search for optimal topology construction comprises providing a transposition search for optimal graph embedding.

9. The method according to claim 8, further comprising the step of performing graph index permutations in a transposition search for optimal graph embedding.

10. The method according to claim 1, wherein said method is employed in a deBruijn interconnection network.

11. The method according to claim 1, wherein said method is employed in constructing overlay topologies for distributed indexing applications.

12. The method according to claim 1, wherein said method is employed in mapping application partitions to distributed server nodes.

13. An apparatus for providing a transposition search for optimal topology construction, said apparatus comprising:
an arrangement for evaluating an objective function for each transposition of a current index permutation state;
an arrangement for selecting a transposition corresponding to a gradient of an objective function; and
an arrangement for continuing the transposition search via following a gradient.

14. The apparatus according to claim 13, wherein said selecting arrangement is adapted to select a transposition corresponding to a gradient of an objective function at convex regions of an index permutation space.

15. The apparatus according to claim 13, wherein said arrangement for continuing the transposition search is adapted to continue the transposition search via following a gradient within a window length equal to the maximum distances between local objective minima.

16. The apparatus according to claim 13, wherein said arrangement for continuing the transposition search is adapted to perform an iterative search which performs a sequence of graph vertex index transpositions.

17. The apparatus according to claim 13, wherein said arrangement for continuing the transposition search is adapted to select a direction of search via computing the difference of an objective function for all index permutations in a local neighborhood of a current permutation.

18. The apparatus according to claim 17, wherein the local neighborhood of the current permutation comprises a set of all permutations accessible through transpositions of node indices.

19. The apparatus according to claim 13, further comprising an arrangement for modeling an overlay topology construction as an embedding of an interconnection graph in a complete network overlay graph.

20. The apparatus according to claim 13, wherein said apparatus is adapted to provide a transposition search for optimal graph embedding.

21. The apparatus according to claim 20, further comprising an arrangement for performing graph index permutations in a transposition search for optimal graph embedding.

22. The apparatus according to claim 13, wherein said apparatus is employed in a deBruijn interconnection network.

23. The apparatus according to claim 13, wherein said apparatus is employed in constructing overlay topologies for distributed indexing applications.

24. The apparatus according to claim 13, wherein said apparatus is employed in mapping application partitions to distributed server nodes.

25. A program storage device readable by machine, tangibly embodying a program of instructions executable by the machine to perform method steps for providing a transposition search for optimal topology construction, said method comprising the steps of:
evaluating an objective function for each transposition of a current index permutation state;
selecting a transposition corresponding to a gradient of an objective function; and
continuing the transposition search via following a gradient.
